(19) United States
(12) Patent Application Publication
(10) Pub. No.: US 2026/0370071 A1
(43) Pub. Date: Nov. 19, 2026

(54) WOUND-FIELD ROTOR

(71) Applicant: DENSO CORPORATION, Kariya-city (JP)

(72) Inventors: Hiroyuki TSUCHIYA, Kariya-city (JP); Yoshimasa KANEDA, Kariya-city (JP)

(21) Appl. No.: 19/738,767

(22) Filed: Jul. 13, 2026

Related U.S. Application Data
(63) Continuation of application No. PCT/JP2025/001729, filed on Jan. 21, 2025.

(30) Foreign Application Priority Data
Feb. 6, 2024 (JP) 2024-016657

(51) Int. Cl. H02K 1/26; H02K 1/24; H02K 3/52

(52) U.S. Cl. CPC H02K 1/26; H02K 1/24; H02K 3/527

(57) ABSTRACT

A rotor (60) includes a rotor core (61), a field winding (70), and a circuit module (106). The circuit module has a component holder (141) that holds an electrical component. The component holder has a first surface and a second surface opposite the first surface in an axial direction of the rotor. Wire ends, which are ends of wires leading from the field winding and the electrical component, extend from the component holder and are joined together on the first surface. A support member (163, 181) is provided on the first surface of the component holder in a state of surrounding a joint between the wire ends.

### CROSS REFERENCE TO RELATED DOCUMENT

The present application claims the benefit of priority of Japanese Patent Application No. 2024-016657 filed on Feb. 6, 2024, the disclosure of which is incorporated in its entirety herein by reference.

### Technical Field

This disclosure generally relates to a wound-field rotor for use in a wound-field rotating electrical machine.

### BACKGROUND ART

A typical wound-field rotating electrical machine includes a rotor which has a rotor core with a plurality of main poles (i.e., magnetic salient poles) arranged in a circumferential direction, and field windings wound around the main poles. The rotating electrical machine described in First Patent Document includes a circuit module which has capacitors and diodes as electrical components disposed at an axial end portion of the rotor. The circuit module includes a component holder that holds the electrical components and also holds portions of field windings and conductors extending from the electrical components. The conductors have ends joined to each other. More specifically, the conductors are held in the component holder with tip portions thereof extending in the axial direction. The tip portions of the conductors are joined to each other by welding.

### PRIOR ART DOCUMENT

### Patent Document

Patent Document 1: Japanese Unexamined Patent Application Publication No. 2020-124100

### SUMMARY OF THE INVENTION

In the above-described structure, the tip portions of the conductors are arranged to protrude from the component holder in the axial direction of the rotor and joined to each other. This layout leads to a risk that the joints of the tip portions of the conductors may separate from each other due to centrifugal force during rotation of the rotor or rotational fluctuations.

This disclosure has been made in view of the above problem. It is an object of this disclosure to provide a wound-field rotor designed to ensure stability of joints of conductors thereof.

According to one aspect in this disclosure, there is provided wound-field rotor which comprises: (a) a rotor core having a plurality of main poles provided for respective magnetic poles; (b) a field winding formed by winding a conductive wire around the main poles; and (c) a circuit module disposed on a first axial end of the rotor core and having an electrical component connected to the field winding. The circuit module includes a component holder that holds the electrical component. The component holder has a first surface and a second surface opposite to each other in an axial direction of the wound-field rotor. The first surface faces away from the rotor core. Wire ends, which are ends of wires leading from the field winding and the electrical component, extend from the component holder and are joined together over the first surface. A support member (163, 181) is provided on the first surface of the component holder in a state of surrounding a joint between the wire ends.

In the wound-field rotor having the configuration described above, the wire ends of the wires leading from the field winding and the electrical component extend over the first surface of the component holder as described above. The first surface of the component holder faces away from the rotor core. This configuration facilitates an operation for joining the wire ends together. However, the configuration in which the wire ends extend over the first surface of the component holder, which faces away from the rotor core, leads to a concern that peeling of the joint between the wire ends may occur when subjected to centrifugal force generated during rotation of the rotor or rotation fluctuations.

In order to alleviate the above drawback, the above-described configuration has the support member arranged on the first surface of the component holder in a state of surrounding the joint between the wire ends, thereby suppressing displacement or deformation of the wire ends when subjected to centrifugal force or rotational fluctuations generated during rotation of the rotor. This ensures stability of the joints of the wire ends during rotation of the rotor.

### BRIEF DESCRIPTION OF DRAWINGS

The above and other objects, features, and advantages of the present disclosure will become more apparent from the following detailed description with reference to the accompanying drawings.

In the drawings:

FIG. 1 is an overall configuration diagram of a control system for a rotating electrical machine;

FIG. 2 is a diagram showing an inverter and a peripheral configuration thereof;

FIG. 3 is a cross-sectional view of a rotor and a stator;

FIG. 4 is a diagram showing an electrical circuit installed in a rotor

FIG. 5 is a perspective view showing an overall configuration of a rotor;

FIG. 6 is a perspective view showing a state in which a cover and a coil end cover are removed in the rotor;

FIG. 7 is an exploded perspective view of a rotor;

FIG. 8 is a longitudinal sectional view of a rotor;

FIG. 9 is an exploded perspective view showing a winding unit in a rotor main portion;

FIG. 10 is a cross-sectional view showing a cross-sectional structure of a part of the rotor main portion;

FIG. 11 is a perspective view of a busbar module;

FIG. 12 is a diagram showing an internal configuration of a busbar module;

FIG. 13 is an exploded perspective view of a circuit module;

FIG. 14 is a diagram showing an internal configuration of a component holder;

FIG. 15 is a perspective view showing a configuration of an axial end portion of a rotor main portion;

FIG. 16 is a perspective view showing a state in which busbar module are assembled to a rotor main portion;

FIG. 17 is a perspective view showing a state in which a component holder is secured to a rotor main portion;

FIG. 18 is a plan view of busbar modules and a component holder as viewed from outside the busbar modules in a state where they are overlapped;

FIG. 19 is an enlarged perspective view showing a portion where wiring connection is performed in a component holder;

FIG. 20 is a longitudinal sectional view showing a cross-section of a wire connection arrangement in a component holder;

FIG. 21 is a diagram for explaining arrangements of connecting wires of a field winding;

FIG. 22 is a diagram schematically showing connection of first coil modules arranged in a circumferential direction;

FIG. 23(a) is a partial plan view of busbar modules and a component holder as viewed from outside a second surface of the component holder;

FIG. 23(b) is a cross sectional view taken along lines 23B-23B in FIG. 23(a);

FIG. 24 is a perspective view of a busbar module and a component holder as viewed from outside a second surface of the component holder;

FIG. 25 is a longitudinal sectional view showing a configuration near a coil end of a field winding;

FIG. 26 is an enlarged perspective view showing a portion where wiring connection is performed in a component holder;

FIG. 27 is a longitudinal sectional view showing a cross section of wire connection arrangement in a component holder;

FIG. 28 is a longitudinal sectional view showing a cross section of wire connection arrangement in a component holder;

FIG. 29 is a longitudinal sectional view showing a cross section of wire connection arrangement in a component holder;

FIG. 30 is a longitudinal sectional view showing a cross section of a wire connection arrangement in a component holder;

FIG. 31 is a longitudinal sectional view showing a cross section of a wire connection arrangement in a component holder;

FIG. 32 is a longitudinal sectional view showing a cross section of a wire connection arrangement in a component holder;

FIG. 33 is a schematic view showing an arrangement of first coil modules of respective poles produced by continuously winding a conductive wire; and

FIG. 34 is a diagram for explaining a retention structure for connecting wires in another example.

### MODES FOR CARRYING OUT THE INVENTION

An embodiment of a wound-field rotating electrical machine according to the present disclosure will be described with reference to the drawings. The rotating electrical machine is used, for example, as a travel power source in an electric vehicle such as an electric vehicle or a hybrid vehicle.

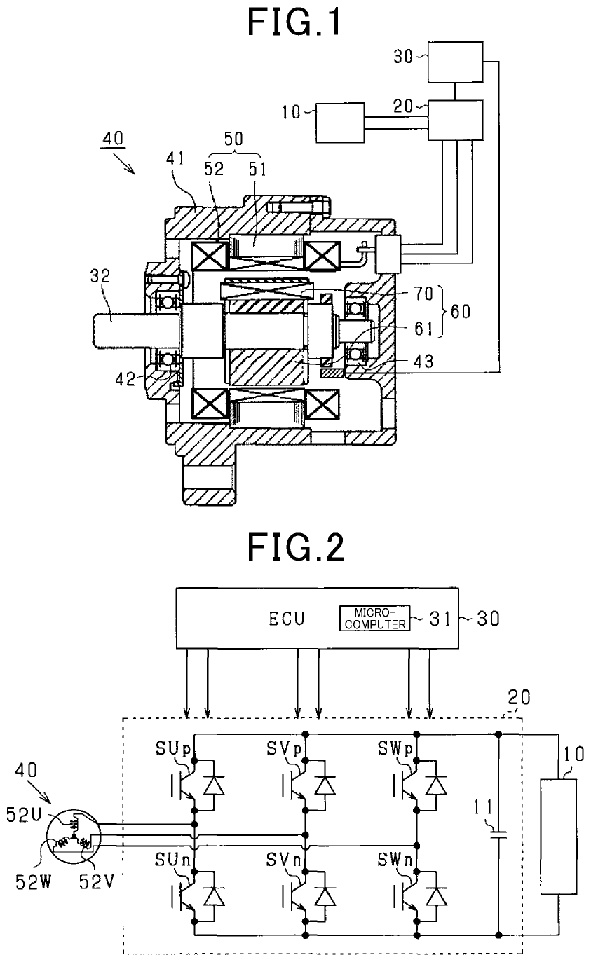

First, a control system including a rotating electrical machine will be described with reference to FIG. 1. The control system includes the DC power source 10, the inverter 20, the controller 30, and the rotating electrical machine 40. The rotating electrical machine 40 is a self-excited wound-field synchronous machine. For example, the rotating electrical machine 40, the inverter 20, and the controller 30 may be configured as a mechanical-electrical integrated drive device, or each of the rotating electrical machine 40, the inverter 20, and the controller 30 may be configured as an individual component.

The rotating electrical machine 40 includes the housing 41, and the stator 50 and the rotor 60 disposed in the housing 41. The rotating electrical machine 40 of the present embodiment is an inner-rotor type rotating electrical machine in which the rotor 60 is disposed on a radially inner side of the stator 50.

The stator 50 includes the stator core 51 and stator windings 52. The stator windings 52 may be made of, for example, copper wires and include U-, V-, and W-phase windings 52U, 52V, and 52W shifted from each other by 120° in electrical angle.

The rotor 60 includes the rotor core 61 and the field winding 70. The field winding 70 is preferably configured using, for example, an aluminum wire having a small specific gravity and being easy to mold, as a conductive wire material. Note that the conductive wire material of the field winding 70 is not limited to the aluminum wire, and may be, for example, a copper wire, CNT (carbon nanotube), or the like. The rotating shaft 32 is assembled in a center hole formed in the rotor core 61. The rotating shaft 32 is rotatably supported by the housing 41 using the bearings 42 and 43.

The inverter 20, as illustrated in FIG. 2, includes series-connected units including U, V, and W-phase upper arm switches SUp, SVp, and SWp and U, V, and W-phase lower arm switches SUn, SVn, and SWn. The U, V, and W-phase windings 52U, 52V, and 52W have first ends connected to connection points between the upper arm switches SUp, SVp, and SWp and the lower arm switches SUn, SVn, and SWn. The U, V, and W-phase windings 52U, 52V, and 52W have second ends connected together at a neutral point. In other words, the stator windings 52 are star-connected. However, the stator windings 52 may be delta-connected. In the present embodiment, each of the switches SUp to SWn is made of, for example, an IGBT. A freewheel diode is connected in anti-parallel to each of the switches SUp to SWn.

The positive terminal of the DC power source 10 is connected to collectors of the U, V, and W-phase upper arm switches SUp, SVp, and SWp. The negative terminal of the DC power source 10 is connected to emitters of the U, V, and W-phase lower arm switches SUn, SVn, and SWn. The smoothing capacitor 11 is connected in parallel to the DC power source 10.

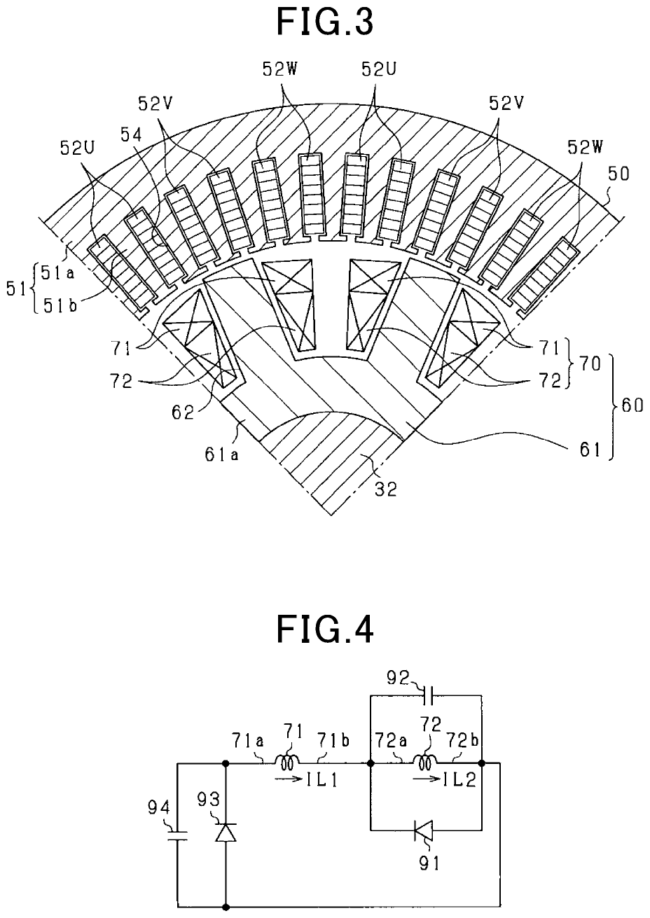

Next, the stator 50 and the rotor 60 will be described with reference to FIG. 3.

Both the stator 50 and the rotor 60 are coaxially disposed with the rotating shaft 32. In the following discussion, a direction in which the rotating shaft 32 extends will also be referred to as an axial direction, a direction extending radially from the center of the rotating shaft 32 will be referred to as a radial direction, and a direction extending circumferentially around the rotating shaft 32 will be referred to below as a circumferential direction.

The stator core 51 is formed by a stack of steel plates made of a soft magnetic material and has the ring-shaped back yoke 51a and the teeth 51b extending radially inward from the back yoke 51a. A plurality of slots 54 are formed between the adjacent teeth 51b and arranged adjacent to each other in the circumferential direction. The stator windings 52 include phase windings which are disposed in the slots 54 in a predetermined order. For example, the stator 50 may be designed to have a coil-segment arrangement in which a plurality of conductor segments are disposed in the slots 54 to constitute the stator windings 52; however, the arrangement of the stator windings 52 is arbitrary.

The rotor core 61 is made of a soft magnetic material and is composed of, for example, a stack of steel plates. The rotor core 61 has the cylindrical portion 61a having a cylindrical shape, and a plurality of main poles 62 projecting radially outward from the cylindrical portion 61a. The field winding 70 is wound around the main poles 62 in the form of a concentrated winding. In the present embodiment, eight main poles 62 are arranged at equal intervals away from each other in the circumferential direction.

The field winding 70 includes the first winding 71 and the second winding 72. The first winding 71 is wound on a radially outer side of each of the main poles 62, while the second winding 72 is wound on a radially inner side of each of the main poles 62 adjacent to the first winding 71. On each of the main poles 62, winding directions of the first winding 71 and the second winding 72 are the same as each other. Further, among the main poles 62 adjacent in the circumferential direction, a winding direction of each of the first and second windings 71 and 72 wound around one of the main poles 62 is opposite to a winding direction of each of the first and second windings 71 and 72 wound around the other of the main poles 62. Such a layout of the first and second windings 71 and 72 causes magnetization directions to be opposite to each other between the main poles 62 adjacent in the circumferential direction. In the rotor 60, a plurality of magnetic poles (i.e., field poles) arranged in the circumferential direction are created by the main poles 62 of the rotor core 61 and the field winding 70 wound around the respective main poles 62.

FIG. 4 is a diagram showing an electrical circuit including the first and second windings 71 and 72 in the rotor 60. The first winding 71 and the second winding 72 are connected in series by connecting the second end 71b of the first winding 71 and the first end 72a of the second winding 72 to each other. The diode 91 and the capacitor 92 are connected in parallel to the second winding 72, respectively. Further, the diode 93 and the capacitor 94 are connected in series to a series-connected unit of the first winding 71 and the second winding 72, respectively. In the following discussion, the diode 91 and the capacitor 92 connected in parallel to the second winding 72 will also be referred to as the parallel diode 91 and the parallel capacitor 92, respectively. Further, the diode 93 and the capacitor 94 connected in series to the series-connected unit of the first winding 71 and the second winding 72 will also be referred to as the series diode 93 and the series capacitor 94, respectively. The capacitors 92 and 94 are, for example, ceramic capacitors or film capacitors.

The parallel diode 91 has a cathode connected to the first end 72a of the second winding 72 and an anode connected to the second end 72b of the second winding 72. This causes an electrical current to flow in one direction from the anode toward the cathode of the parallel diode 91 in a closed circuit including the second winding 72 and the parallel diode 91. Further, the series diode 93 has a cathode connected to the first end 71a of the first winding 71 and an anode connected to the second end 72b of the second winding 72. This rectifies a field current flowing through each of the windings 71 and 72. In the present embodiment, the number of turns of the second winding 72 is larger than the number of turns of the first winding 71.

Referring back to FIG. 2, the controller 30 is made of an electronic control unit (ECU) mainly configured by the microcomputer 31. The microcomputer 31 includes a CPU (Central Processing Unit). Functions provided by the microcomputer 31 may be implemented by software recorded in a non-transitory tangible storage medium and a computer that executes the software, by hardware only, or by a combination thereof. For example, when the microcomputer 31 is implemented by hardware electronic circuitry, the microcomputer 31 can be implemented by a digital circuit including a large number of logic circuits or by an analog circuit. For example, the microcomputer 31 executes a program stored in a non-transitory tangible storage medium serving as a storage unit provided in the microcomputer 31 itself. The program includes a task for controlling operation of the rotating electrical machine 40. By executing a set of instructions constituting the program, a method corresponding to the program is executed. The storage unit is, for example, a non-volatile memory. Note that the program stored in the storage unit may be updated via a communication network such as the Internet, for example, by OTA (Over The Air) or the like.

The controller 30 generates drive signals for turning on or off the switches SUp to SWn constituting the inverter 20. Specifically, the controller 30 generates the drive signals for turning on or off the switches SUp to SWn to convert DC power output from the DC power source 10 into AC power and supply the AC power to the U-phase, V-phase, and W-phase windings 52U, 52V, and 52W, and outputs the generated drive signals to gates of the switches SUp to SWn. In each phase, the upper-arm switch Sup, SVp, or SWp and the lower-arm switch Sun, SVn, or SWn are alternately turned on with a dead time interposed therebetween.

The controller 30 turns on or off each of the switches SUp to SWn so as to cause a total current or combined current of a fundamental-wave current and a high-frequency current (specifically, a high-frequency excitation current) having a frequency higher than that of the fundamental-wave current to flow through each of the phase windings 52U, 52V, and 52W. The fundamental-wave current is a current mainly for causing the rotating electrical machine 40 to generate torque. The high-frequency current is a current mainly for exciting the first and second windings 71 and 72 constituting the field winding 70 to induce a field current in the field winding 70. Phase currents flowing through the phase windings 52U, 52V, and 52W are shifted from each other by 120° in electrical angle.

Note that the high-frequency current to be passed through the stator windings 52 may be a harmonic current having a fluctuation frequency that is N times (where N is an integer of 2 or more) the frequency of the fundamental-wave current, or may be a current having a fluctuation frequency deviating from N times the frequency of the fundamental-wave current.

When the high-frequency current flows through the stator windings 52, it causes voltages to be induced in the first and second windings 71 and 72, so that the field current flows. The induced voltages developed at the first and second windings 71 and 72 are identical in phase with each other. Currents IL1 and IL2 flowing through the first and second windings 71 and 72 include a frequency component of the high-frequency current.

In the electrical circuit shown in FIG. 4, when the first and second windings 71 and 72 are excited accompanying energization of the stator windings 52, a current flows from the first winding 71 to the second winding 72. Further, when a voltage across both ends of the second winding 72 exceeds a forward voltage of the parallel diode 91, the current IL2, which is larger than the current IL1 flowing through the first winding 71, flows through the second winding 72 in a closed circuit including the second winding 72 and the parallel diode 91. The current flowing through the closed circuit including the second winding 72 and the parallel diode 91 results in an increase in DC component of the field current. This causes a DC component of magnetic flux of the rotor 60 to be increased, which results in an increase in degree of torque produced by the rotating electrical machine 40.

Further, when the current flows through the closed circuit including the second winding 72 and the parallel diode 91, a part of the current flows through the first winding 71. In this case, a direction of the current IL1 flowing through the first winding 71 and a direction of the current IL2 flowing through the second winding 72 are opposite to each other. This reduces pulsation of the field current, which is a total value of the respective currents IL1 and IL2, which results in a reduction in torque pulsation of the rotating electrical machine 40.

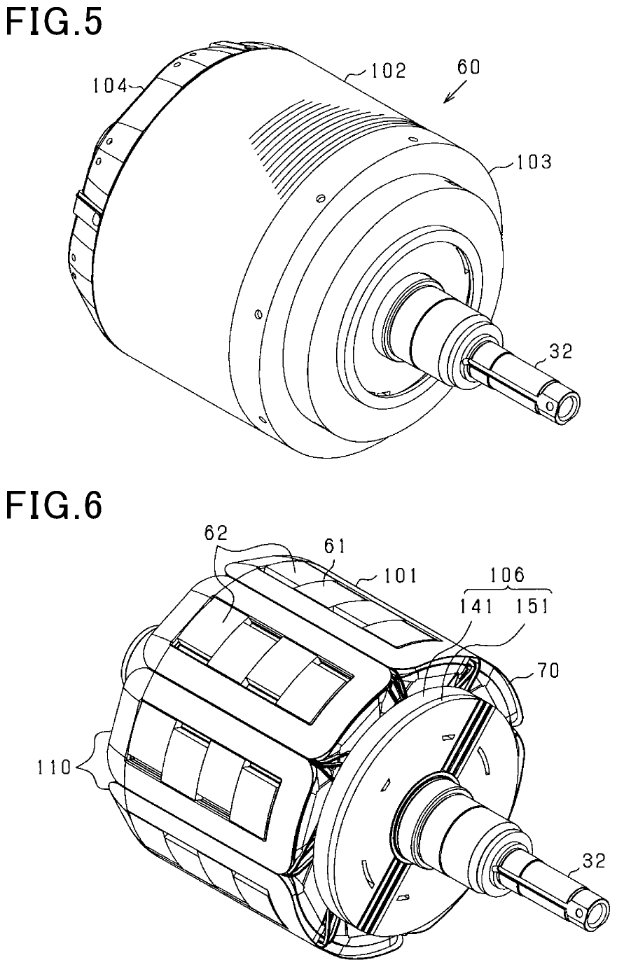

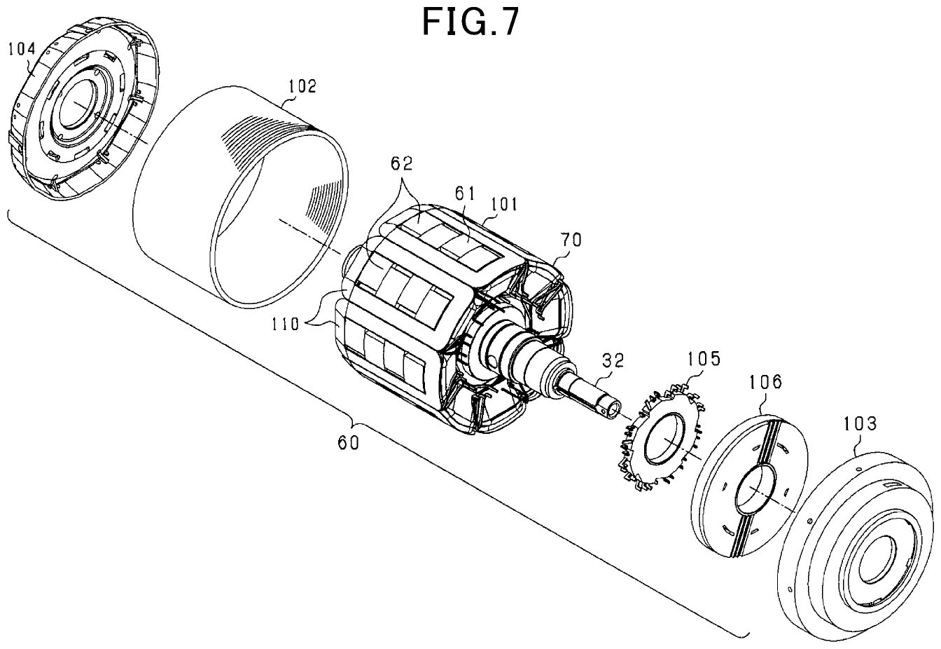

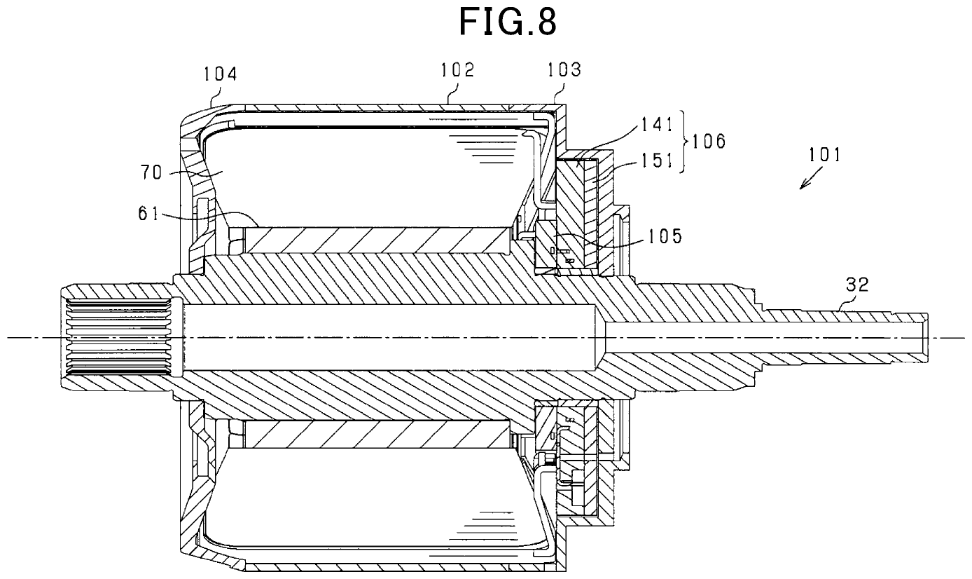

Next, the configuration of the rotor 60 will be described in more detail. FIG. 5 is a perspective view showing an overall configuration of the rotor 60. FIG. 6 is a perspective view showing a state in which the outer peripheral cover 102 covering the rotor main portion 101 and the coil end covers 103 and 104 are removed from the rotor 60. FIG. 7 is an exploded perspective view of the rotor 60. FIG. 8 is a longitudinal sectional view of the rotor 60.

The rotor 60 is generally classified into the rotor main portion 101, the cylindrical outer peripheral cover 102 which surrounds an outer periphery of the rotor main portion 101, the coil end covers 103 and 104 attached to axially-opposed ends of the rotor main portion 101, and the busbar module 105, and the circuit module 106 disposed on one of the axial opposite ends of the rotor main portion 101. The rotor main portion 101 includes the rotor core 61 and the field winding 70. The rotating shaft 32 is fit in a center hole of the rotor core 61. The field winding 70 is composed of a plurality of winding units 110 arranged in the circumferential direction.

The busbar module 105 and the circuit module 106 are fixed to the rotating shaft 32 in a state where the rotating shaft 32 is inserted through respective hollow portions thereof. The busbar module 105 and the circuit module 106 are, therefore, located to face coil ends of the field winding 70 in the axial direction. The outer peripheral cover 102 is configured, for example, by using yarn, which is a string-like body, and winding the yarn in multiple layers on outer peripheries of the winding units 110 assembled to the rotor core 61.

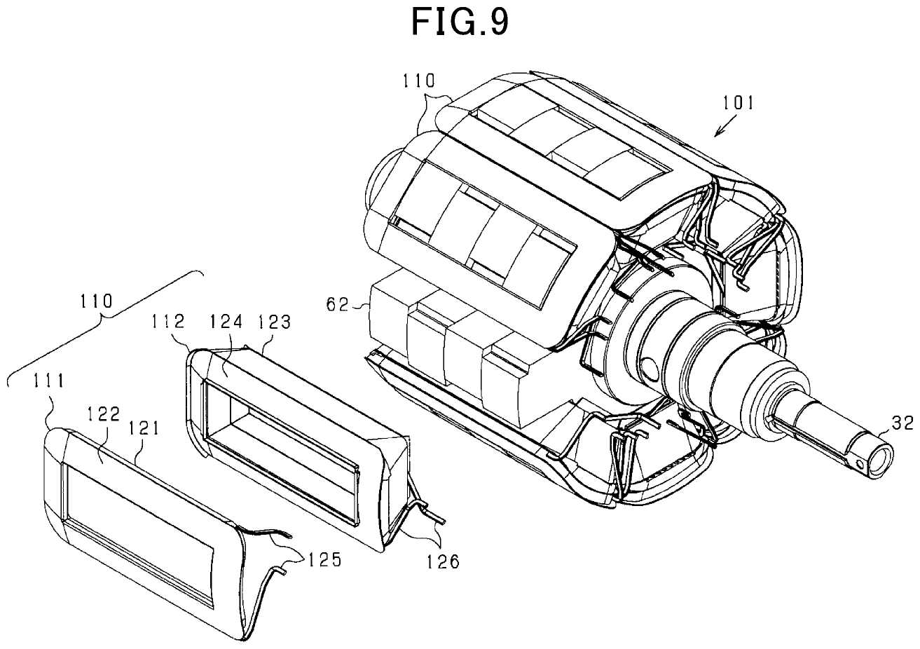

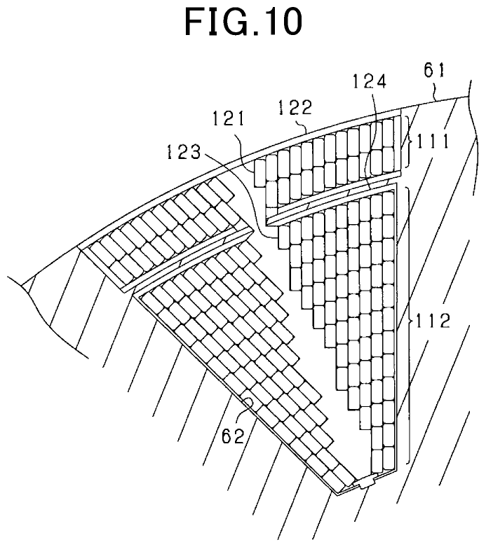

FIG. 9 is a perspective view showing the winding units 110 in an exploded manner in the rotor main portion 101. FIG. 10 is a cross-sectional view showing a cross-sectional structure of a part of the rotor main portion 101.

The rotor main portion 101 has a plurality of winding units 110 provided for respective magnetic poles of the rotor 60. Each of the winding units 110 is shaped in an annular form to have a hollow portion and has a longitudinal direction oriented in the axial direction. The winding units 110 are assembled to the rotor core 61 with the main poles 62 of the rotor core 61 being disposed in the hollow portions thereof. In the present embodiment, a pole coil is configured by the winding units 110.

Each of the winding units 110 includes the first coil module 111 located on a radially outer side in a state of being mounted to the main poles 62, and the second coil module 112 located on a radially inner side. The first coil module 111 is a coil module corresponding to the first winding 71, and the second coil module 112 is a coil module corresponding to the second winding 72.

The first coil module 111 has the annular coil body 121 formed by winding a conductive wire made of a rectangular wire multiple times in the circumferential direction and the radial direction. The first coil module 111 also has the thin-plate-shaped insulator 122 provided integrally with the coil body 121. The insulator 122 has portions which cover a radially outer portion and a radially inner portion of the coil body 121 which extend in the circumferential direction. The insulator 122 also has a portion which extends in the radial direction and covers the hollow portion of the coil body 121. In other words, the coil body 121 has the radially outer portion, the radially inner portion, and the hollow portion which are covered by the insulator 122.

The second coil module 112 has the annular coil body 123 formed by winding a conductive wire made of a rectangular wire multiple times in the circumferential direction and the radial direction. The second coil module 112 also has the thin-plate-shaped insulator 124 provided integrally with the coil body 123. The insulator 124 has portions which cover a radially outer portion and a radially inner portion of the coil body 123 which extend in the circumferential direction. The insulator 124 also has a portion which extends in the radial direction and covers the hollow portion of the coil body 123. In other words, the coil body 123 has the radially outer portion, the radially inner portion, and the hollow portion which are covered by the insulator 124.

The coil body 121 of the first coil module 111 is, for example, an alpha-wound coil made by winding a conductive wire in the shape of alpha winding. The coil body 123 of the second coil module 112 is a continuously-wound coil made by winding a conductive wire continuously in a given circumferential direction. The first coil module 111 has two conductive wire ends 125 drawn out in the axial direction. Similarly, the second coil module 112 has two conductive wire ends 126 drawn out in the axial direction. The winding units 110 are arranged in the circumferential direction with the conductive wire ends 125 and 126 being connected to each other, so that the first coil modules 111 provided on the respective main poles 62 are connected in series, and the second coil modules 112 provided on the respective main poles 62 are connected in series. A portion of each of the coil modules 111 and 112 where the conductive wire is wound around the main poles 62 is referred to as a winding portion. End portions of the conductive wires extending from the winding portions of the coil modules 111 and 112 correspond to the conductive wire ends 125 and 126.

The conductive wire used for each of the coil bodies 121 and 123 is, for example, a rectangular wire having a substantially rectangular cross-sectional shape. Specifically, the rectangular wire has a substantially rectangular shape in cross section. The rectangular wire includes a conductor portion made of aluminum and an insulating layer covering the conductor portion. However, a round wire having a circular cross section may also be used as the conductive wire. The structure of each of the coil modules 111 and 112 is arbitrary. For example, both of the coil bodies 121 and 123 may be continuously wound coils.

As shown in FIG. 10, the conductive wire of the first coil module 111 is wound in two layers stacked on one another in the radial direction. The conductive wire of the second coil module 112 is wound in twelve layers stacked on one another in the radial direction. Although the number of layers of each of the coil modules 111 and 112 is arbitrary, it is preferable that the number of layers of the second coil module 112 be larger than the number of layers of the first coil module 111. In each of the coil modules 111 and 112, the number of turns in the circumferential direction (in other words, the number of conductive wire segments arranged in the circumferential direction) differs between the layers, and the number of turns is larger in the radially outer layer than in the radially inner layer. This results in an improvement in the space factor of the field windings 70.

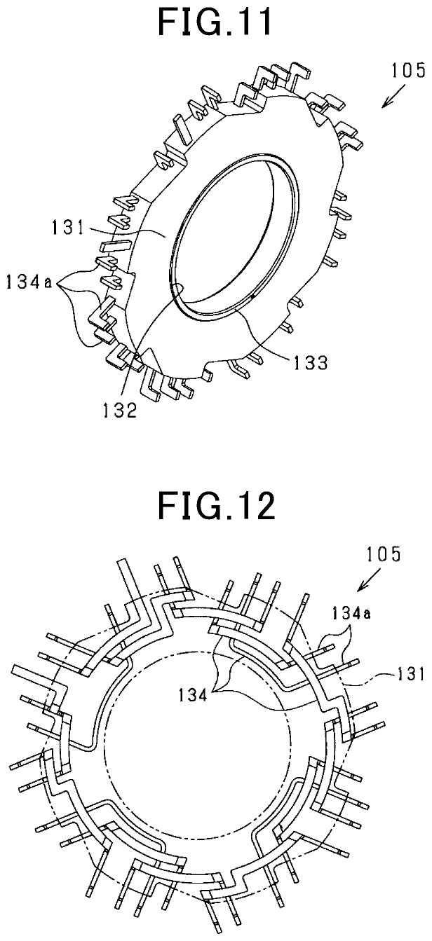

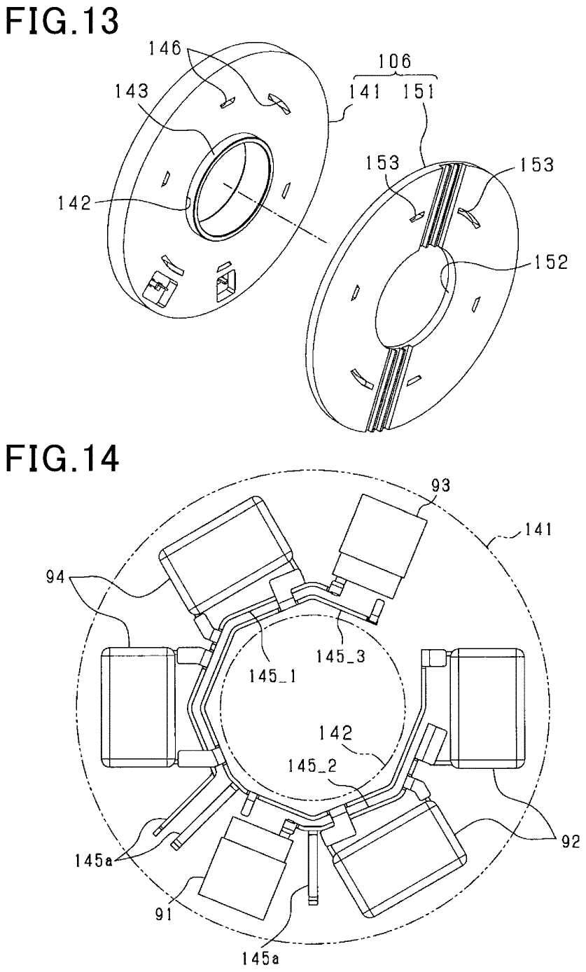

Next, the busbar module 105 and the circuit module 106 will be described below. FIG. 11 is a perspective view of the busbar module 105. FIG. 12 is a diagram showing an internal configuration of the busbar module 105. FIG. 13 is a perspective view showing the circuit module 106 in an exploded manner into the component holder 141 and the heat dissipation plate 151. FIG. 14 is a diagram showing an internal configuration of the component holder 141.

As shown in FIG. 11 and FIG. 12, the busbar module 105 has the main body 131 formed by a resin molded body and also has the center hole 132 formed in a center portion thereof. In the center hole 132, the high-rigidity cylindrical member 133 made of, for example, metal is assembled. The busbar module 105 is assembled to the rotating shaft 32 in a state where the rotating shaft 32 is inserted through an inner peripheral side of the cylindrical member 133.

The main body 131 has embedded therein a plurality of busbars 134 used to electrically connect the coil modules 111 and 112 for respective magnetic poles. In the main body 131, each of the busbars 134 is arranged so as to extend in the circumferential direction around the center hole 132. Each of the busbars 134 has a length with ends which define the arms 134a extending in the radial direction. The arms 134a project radially outward from an outer peripheral surface of the main body 131. Each of the arms 134a has a tip portion bent in the axial direction.

The busbars 134 of the busbar module 105 include:
seven busbars 134 for connecting the first coil modules 111 for eight magnetic poles in series; and
seven busbars 134 for connecting the second coil modules 112 for eight magnetic poles in series.

Each of the arms 134a of the busbars 134 is connected to a respective one of the conductive wire ends of the coil modules 111 and 112. In addition, the busbars 134 include busbars 134 serving as both ends of the series connection of the first coil modules 111 for eight magnetic poles, and busbars 134 serving as both ends of the series connection of the second coil modules 112 for eight magnetic poles.

As shown in FIG. 13 and FIG. 14, the circuit module 106 has the component holder 141 in which electrical components are accommodated, and the heat dissipation plate 151 stacked on the component holder 141. The component holder 141 and the heat dissipation plate 151 have a disk shape and have the same outer diameter dimensions. The component holder 141 and the heat dissipation plate 151 are integrated in a state where axial end surfaces thereof are joined to each other (see FIG. 7).

The component holder 141 is made of a resin molded body which h the center hole 142 formed in a center portion thereof. The center hole 142 has fitted therein the high-rigidity hollow cylindrical member 143 made of, for example, metal. The component holder 141 is affixed to the rotating shaft 32 with the rotating shaft 32 inserted through an inner peripheral side of the cylindrical member 143.

The component holder 141 includes electrical components constituting the electrical circuit described in FIG. 4, and includes a plurality of busbars 145 electrically connected to the electrical components. The electrical components and the busbars 145 are embedded in resin in the component holder 141.

The component holder 141 has retained therein electrical components: the diodes 91 and 93 and the capacitors 92 and 94 which are arranged around the center hole 142. Further, the busbars 145 are connected to the respective electrical components. In the present embodiment, the busbars 145 include three busbars 145_1, 145_2, and 145_3. In the component holder 141, the periphery of each electrical component is preferably sealed with a sealing material.

The busbar 145_1 is connected to the diode 93 and the capacitor 94 and also connected to the first end 71a of the first winding 71 in the electrical circuit of FIG. 4. The busbar 145_2 is connected to the diode 91 and the capacitor 92 and also connected to the second end 71b of the first winding 71 and the first end 72a of the second winding 72 in the electrical circuit of FIG. 4. The busbar 145_3 is connected to the diodes 91 and 93 and the capacitors 92 and 94 and also connected to the second end 72b of the second winding 72 in the electrical circuit of FIG. 4.

The component holder 141 has the busbars 145 arranged so as to extend in the circumferential direction around the center hole 142. Each of the busbars 145 has the arm 145a extending in the radial direction. The arm 145a extends in the radial direction and has a tip portion bent in the axial direction. The tip portion of the arm 145a is exposed outside the component holder 141 and serves as a connection end portion used to achieve connection with the first winding 71 and the second winding 72.

As shown in FIG. 13, the heat dissipation plate 151 is fixed to one (i.e., the right surface, as viewed in the drawing) of axially-opposed major surfaces of the component holder 141 which faces away from the rotor core 61. Such securement of the heat dissipation plate 151 to the component holder 141 causes the entire major surface of the component holder 141 which faces away from the rotor core 61 to be covered with the heat dissipation plate 151. The heat dissipation plate 151 is made of, for example, aluminum. However, the heat dissipation plate 151 may alternatively be made of other materials as long as the material has excellent heat dissipation properties, and may be made of, for example, an aluminum alloy or copper. The center hole 152 is located in the center portion of the heat dissipation plate 151. In the center hole 152, the cylindrical member 143 integrated with the component holder 141 is assembled.

The securement of the heat dissipation plate 151 to the axial major surface of the component holder 141 causes heat generated by the diodes 91 and 93 and the capacitors 92 and 94 resulting from electrical energization thereof in the component holder 141 to be dissipated via the heat dissipation plate 151.

The component holder 141 has formed therein a plurality of through-holes 146 penetrating in a thickness direction of the component holder 141. The heat dissipation plate 151 has also formed therein a plurality of through-holes 153 penetrating in the thickness direction. The through-holes 146 are located in alignment with the through-holes 153 in the axial direction.

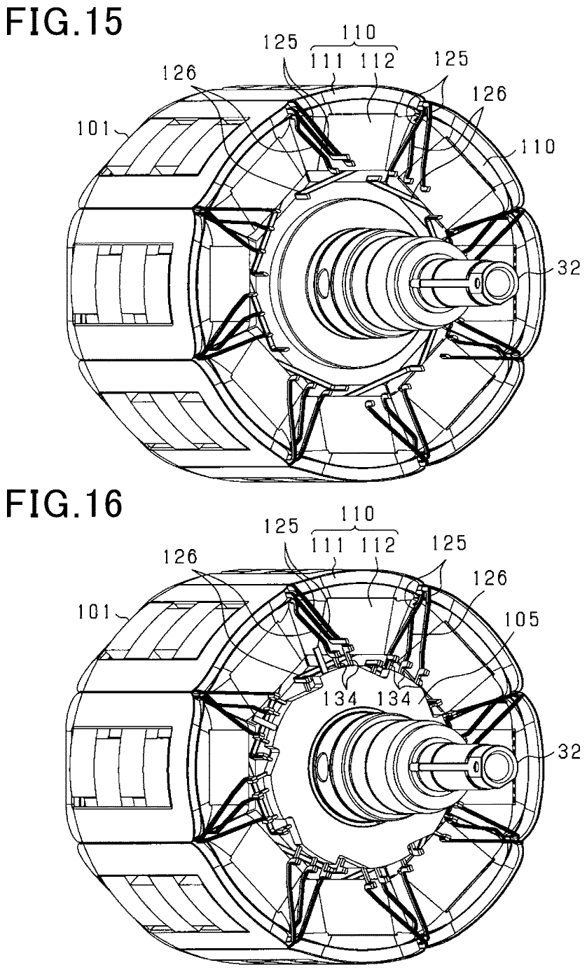

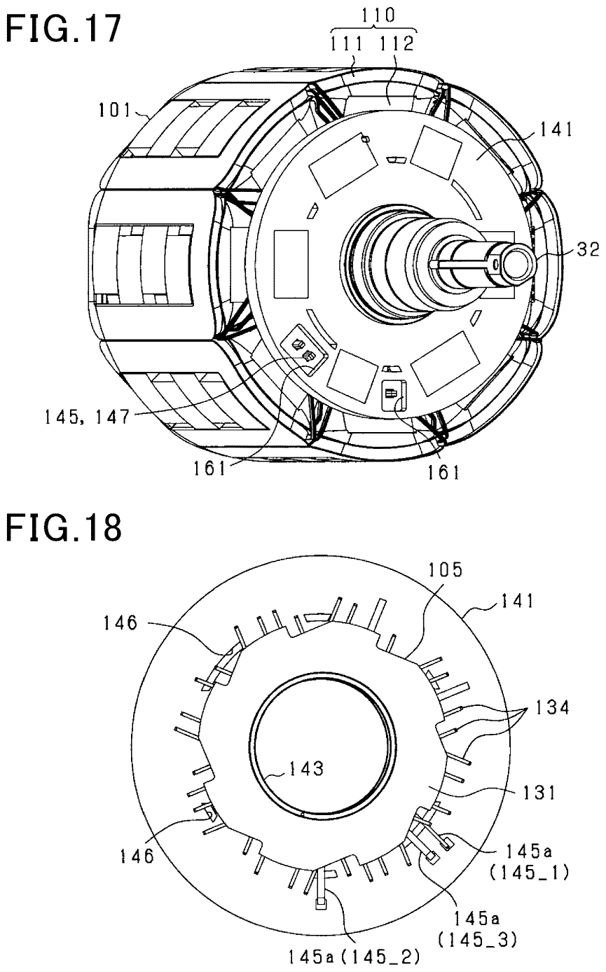

Here, wiring arrangements at coil ends of the field windings 70 will be described with reference to FIG. 15 to FIG. 17. FIG. 15 is a perspective view showing a configuration of an axial end portion of the rotor main portion 101. FIG. 16 is a perspective view showing a state in which the busbar module 105 is secured to one of axial opposite ends of the rotor main portion 101. FIG. 17 is a perspective view showing a state in which the component holder 141 of the circuit module 106 is secured to one of the axial opposite ends of the rotor main portion 101. In other words, FIG. 16 is a perspective view showing a state in which the busbar module 105 is assembled to the configuration shown in FIG. 15, and FIG. 17 is a perspective view showing a state in which the component holder 141 of the circuit module 106 is assembled to the configuration shown in FIG. 16.

In the structure of FIG. 15, the eight winding units 110 are arranged side by side in the circumferential direction of the rotor main portion 101. Each of the winding units 110 has two conductive wire ends 125 drawn out from the first coil module 111 and also has two conductive wire ends 126 drawn out from the second coil module 112. The conductive wire ends 125 and 126 are drawn out such that tip portions thereof are gathered at a position closer to a radial center of the field winding 70 on a radially outer side of the field winding 70.

In the structure of FIG. 16, the arms 134a of the busbars 134 extending from the outer peripheral surface of the main body 131 of the busbar module 105 are respectively joined to the conductive wire ends 125 and 126 of the field windings 70. By assembling the busbar module 105 to the rotating shaft 32, the busbar module 105 is arranged on one of axial opposite sides of the rotor main portion 101, and the tip portions of the conductive wire ends 125 and 126 and the tip portions of the arms 134a face each other in close proximity. In this state, the tip portions of the conductive wire ends 125 and 126 and the tip portions of the arms 134a are joined together by welding or the like.

In FIG. 17, the component holder 141 is placed to overlap the busbar module 105 in the axial direction. In other words, the component holder 141 is secured to the rotating shaft 32, so that the component holder 141 is arranged to face the axial end surface of the busbar module 105. The axial end surface of the component holder 141 has formed therein the recesses 161 recessed in the axial direction. In the recesses 161, connection between the busbars 145 extending from the electrical circuit of the circuit module 106 and the field winding 70 is achieved.

FIG. 18 is a plan view of the busbar module 105 and the component holder 141 which are stacked on one another, as viewed from the busbar module 105. As can be seen from the drawing, the component holder 141 has a larger radial dimension than the busbar module 105, and has a portion located radially outward of the busbar module 105. The arms 134a of the busbars 134 project radially outside the outer periphery of the busbar module 105. The tip portions of the conductive wire ends 125 and 126 and the tip portions of the arms 134a are joined together at positions radially outward of the main body 131 and axially facing the axial end surface of the component holder 141 (see FIG. 16).

The component holder 141 is provided with a plurality of through-holes 146 at positions radially outward of the busbar module 105. Thereby, even in a state where the busbar module 105 and the component holder 141 overlap each other, the through-holes 146 communicate with both sides in the axial direction.

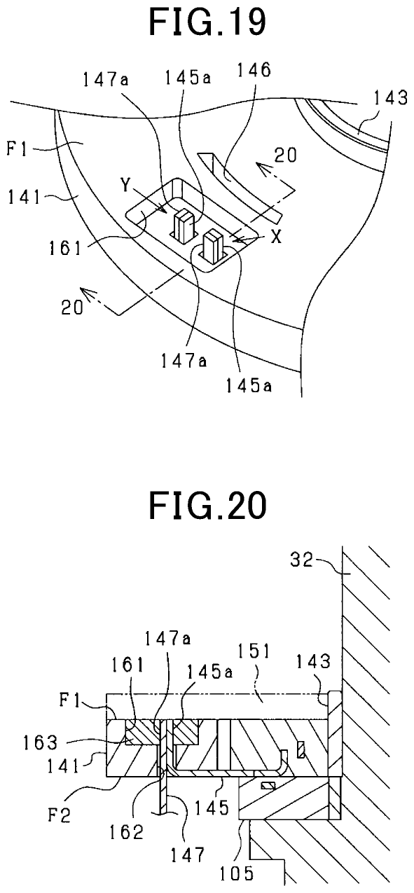

Next, arrangements of wire connections in the component holder 141 will be described. FIG. 19 is an enlarged perspective view showing a portion of the component holder 141 where wiring connection is achieved. FIG. 20 is a longitudinal sectional view showing a cross-section of a portion of the component holder 141 where the wire connections are made, and is a view showing the cross-section taken along line 20-20 of FIG. 19. The component holder 141 has the first surface F1 and the second surface F2 which are opposite to each other in the axial direction. The first surface F1 faces away from the rotor core 61, that is, faces upward as viewed in FIG. 20. The second surface F2 faces the rotor core 61, that is, faces downward as viewed in FIG. 20.

The component holder 141 has the recesses 161 formed in the first surface F1 facing away from the rotor core 61. The tip portions of the arms 145a of the busbars 145 are drawn out into the recess 161. The component holder 141 also has formed therein the through-holes 162 extending in the axial direction from the bottom surfaces of the recesses 161 and communicating the recesses 161 with the second surface F2 of the component holder 141. The busbars 147, which are connection partners of the busbars 145, are inserted through the through-holes 162. The arms 147a of the busbars 147 are drawn out into the recesses 161. The busbars 147 serve as relay busbars, each of which has one end connected to a corresponding one of the conductive wire ends 125 and 126 of the field winding 70. Instead of the busbars 147, any of the conductive wire ends 125 and 126 of the field winding 70 may be used as a connection partner of each of the busbars 145.

In each of the recesses 161, the arms 145a and 147a of the busbars 145 and 147 are joined together, so that the busbars 145 and 147 are electrically connected to each other. In other words, the arms 145a and 147a extend in the axial direction from the first surface F1 of the component holder 141 and are joined to each other by welding in the recesses 161. In the configuration of FIG. 20, the arms 145a and 147a correspond to “wiring end portions.”

Each of the arms 145a and 147a is shaped so as not to protrude outside a corresponding one of the recesses 161, that is, so as not to be on an axially outer side of the first surface F1 of the component holder 141. This avoids physical interference between each of the arms 145a and 147a and the heat dissipation plate 151 when the heat dissipation plate 151 is stacked on the component holder 141.

The support member 163 is disposed inside each of the recesses 161. The support member 163 is formed by filling each of the recesses 161 with a filler. The support member 163 is made of, for example, a resin material. The support member 163 is arranged inside the recess 161 and surrounds a joint between the arms 145a and 147a. In the configuration in which the arms 145a and 147a extend in the axial direction from the component holder 141, centrifugal force acts on the arms 145a and 147a when the rotor 60 rotates, and inconveniences such as peeling of the joined portion may occur. However, since the support member 163 is provided as described above, occurrence of inconveniences such as peeling of the joint between the arms 145a and 147a due to centrifugal force is suppressed.

In a state where the heat dissipation plate 151 is joined to the component holder 141, the axial end surface (i.e., one of the axial opposite end surfaces which faces the first surface F1) of the support member 163 is preferably in physical contact with the heat dissipation plate 151. However, in the state where the heat dissipation plate 151 is joined to the component holder 141, the arms 145a and 147a and the heat dissipation plate 151 are preferably insulated from each other.

Note that FIG. 19 shows a state in which the inside of each of the recesses 161 is not filled with resin for brevity of illustration. Actually, each of the recesses 161 is filled with resin so that the arms 145a and 147a are surrounded by the support member 163.

During manufacturing of the rotor 60, the arms 145a and 147a are welded together using a space in each of the recesses 161 in a state where the arms 145a and 147a are drawn out into the recess 161 of the component holder 141. Thereafter, a filler is filled into the recess 161, and the filler solidifies, whereby the support member 163 is formed in the recess 161. The use of the joining space for the busbars 145 and 147 defined by each of the recesses 161 of the component holder 141 enables the arms 145a and 147a not to protrude outside the first surface F1 facing away from the rotor core 61 of the component holder 141. Further, retention of the joint between the busbars 145 and 147 in each of the recesses 161 is achieved by a simple operation such as resin filling in the recesses 161.

In FIG. 19, two joints X and Y are shown which are established by combining and joining the arms 145a and 147a to each other. The joint X is created by the arms 145a and 147a that are drawn out from the through-hole 162, arranged adjacent to each other in the radial direction, and welded together. On the other hand, the joint Y is created by the arms 145a and 147a, which are drawn out from the through-hole 162, arranged adjacent to each other in the circumferential direction, and then welded together. This layout of the arms 145a and 147a at the joint Y serves to reduce a risk that the arms 145a and 147a may undergo physical damage due to centrifugal force during rotation of the rotor 60 as compared with the joint X.

All the arms 145a and 147a may alternatively be welded as the joints Y in the component holder 141. All the arms 145a and 147a may alternatively be welded as the joints X in the component holder 141.

Next, a configuration of connecting wires, that is, crossover wires connecting the winding units 110 (i.e., pole coils) for respective magnetic poles in the field winding 70 will be described. In the present embodiment, the crossover wires of the field winding 70 are configured by the conductive wire ends 125 and 126 of the coil modules 111 and 112 and the busbars 134 of the busbar module 105. FIG. 21 shows the configuration of the crossover wires. In FIG. 21, for convenience of explanation, only the crossover wires of the first winding 71 (the first coil module 111) are shown.

In FIG. 21, each of the winding units 110 arranged adjacent to each other in the circumferential direction has two conductive wire ends 125 that are drawn out from the radially outer side of the winding unit 110, i.e., the first coil module 111 and extend from the radially outer side toward a radially inner side of the winding unit 110. Specifically, the conductive wire ends 125 extend in a direction intersecting the axial direction (that is, the radial direction) on the axially outer side of the field winding 70. The busbars 134 are joined to the tip portions of the conductive wire ends 125, thereby connecting the first coil modules 111 of the respective poles together in series. The conductive wire ends 125 and the busbars 134 serve as the crossover wires W connecting the first coil modules 111 of the respective poles.

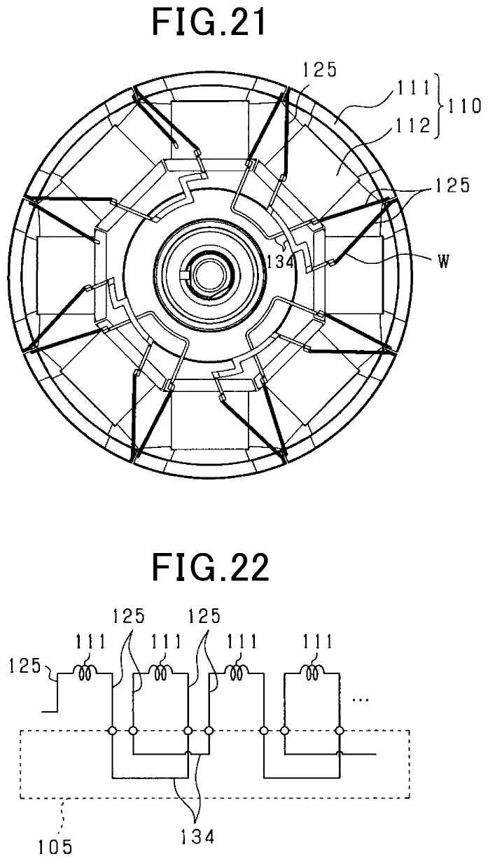

FIG. 22 is a diagram schematically showing the layout of connections of the first coil modules 111 arranged in the circumferential direction. As can be seen in FIG. 22, each of the first coil modules 111 arranged in the circumferential direction has two conductive wire ends 125. The conductive wire ends 125 are connected to the busbars 134 of the busbar module 105, thereby connecting the first coil modules 111 in series via the busbars 134. In two respective first coil modules 111 adjacent in the circumferential direction, the conductive wire ends 125 located on the same side as each other in the circumferential direction (the horizontal direction in the drawing) among both sides in the circumferential direction are connected using one of the busbars 134, so that winding directions of the conductive wires of the first coil modules 111 alternate with each other.

Although not shown in FIG. 21, similar to the first coil modules 111, the second coil module 112 on the radially inner side of each of the winding units 110 has the conductive wire ends 126 extending in a direction intersecting the axial direction on the axially outer side of the field winding 70. The conductive wire ends 126 and the busbars 134 serve as the connecting wires W connecting the second coil modules 112 of the respective poles. In each of the second coil modules 112, one of the two conductive wire ends 126 is provided so as to extend in the radial direction, and the other is provided so as to extend in the circumferential direction (see FIG. 15).

The above-described configuration in which the conductive wire ends 125 and 126 extend in a direction intersecting the axial direction (i.e., the radial direction or the circumferential direction) leads to a concern that the conductive wire ends 125 and 126 may be unintentionally displaced by centrifugal force or force in the rotational direction due to rotational fluctuation during rotation of the rotor 60. In order to alleviate such a drawback, the component holder 141 has formed thereon the protrusions 171 protruding in the axial direction and facing the conductive wire ends 125 and 126 in a direction orthogonal to the axial direction on the second surface F2 facing the rotor core 61. A specific configuration will be described below.

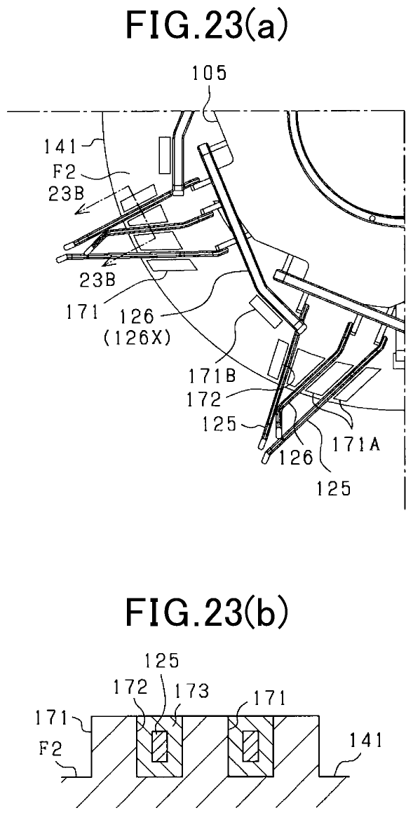

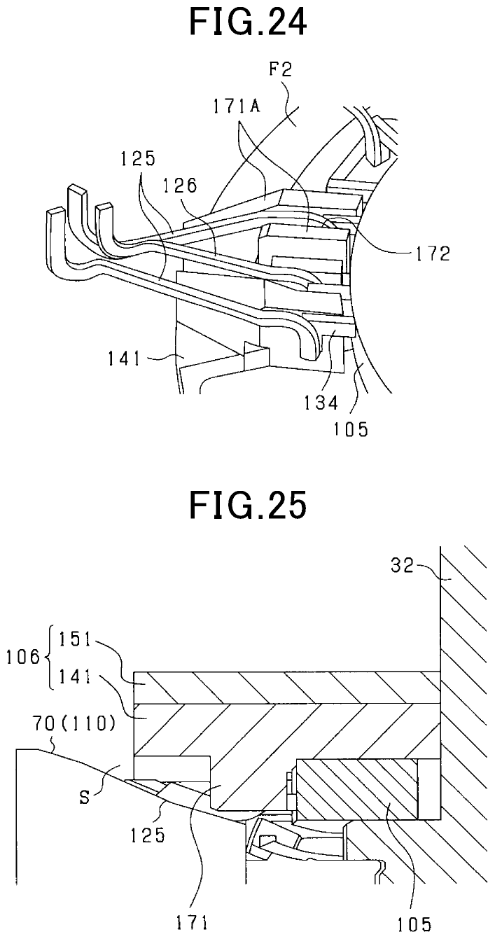

FIG. 23(a) and 23(b) are diagrams showing a configuration of the protrusions 171 provided on the component holder 141. Specifically, FIG. 23(a) is a plan view of the busbar module 105 and the component holder 141 as viewed from outside the second surface F2. FIG. 23(b) is a cross-sectional view taken along line 23B-23B in FIG. 23(a). FIG. 24 is a perspective view of the busbar module 105 and the component holder 141 as viewed from outside the second surface F2. Note that in FIG. 23(a) and FIG. 24, the conductive wire ends 125 and 126 are shown overlapping the component holder 141.

The component holder 141 has the protrusions 171 that are located radially outside the busbar module 105 and extend from the second surface F2 toward the rotor core 61 (the front side of the paper surface in FIG. 23(a)). The protrusions 171 are arranged side-by-side with (at positions adjacent to) the conductive wire ends 125 and 126 in a plan view. The protrusions 171 face the conductive wire ends 125 and 126 in a direction orthogonal to the axial direction.

More specifically, the protrusions 171 include the protrusions 171A and the protrusions 171B. The protrusions 171A extend in the radial direction adjacent to the conductive wire ends 125 and 126 of the coil modules 111 and 112 that extend in the radial direction. The adjacent protrusions 171A are, as clearly illustrated in FIG. 23(a), respectively arranged on circumferentially opposite sides of a corresponding one of the conductive wire ends 125 and 126. In other words, the adjacent protrusions 171A have defined therebetween the groove 172 extending in the radial direction, and a corresponding one of the conductive wire ends 125 and 126 is arranged within the groove 172.

Each of the protrusions 171B extends in the circumferential direction and is arranged adjacent to a corresponding one of the conductive wire ends 126 extending in the circumferential direction (i.e., the conductive wire end 126X illustrated in FIG. 23(a)). The protrusions 171B are located radially outside the conductive wire ends 126X. The protrusions 171B may alternatively be arranged on radially opposite sides of a corresponding one of the conductive wire ends 126X extending in the circumferential direction such that the one of the conductive wire ends 126X is disposed therebetween. In other words, the adjacent protrusions 171B may be disposed to define therebetween the groove 172 in which a corresponding one of the conductive wire ends 126X is disposed.

The protrusions 171 (171A and 171B) function to suppress displacement or deformation of the conductive wire ends 125 and 126 due to centrifugal force and rotational fluctuation during rotation of the rotor 60. This restricts excessive displacement of the conductive wire ends 125 and 126 even when the conductive wire ends 125 and 126 are flexed in the radial direction or the circumferential direction due to centrifugal force or rotational fluctuation during rotation of the rotor 60. This suppresses inconveniences such as occurrence of damage to the conductive wire ends 125 and 126 or breakage of joints between the conductive wire ends 125 and 126 and the busbars 134.

The protrusions 171 are formed by portions of the component holder 141 and serve as resin molded bodies having insulation properties, thereby eliminating a risk that the conductive wire ends 125 and 126 may be short-circuited resulting from contact between the protrusions 171 and the conductive wire ends 125 and 126. The protrusions 171 may alternatively be produced as members discrete from the component holder 141. The protrusions 171 may be formed integrally with the component holder 141 by adhesion, welding, or the like.

The joints between the conductive wire ends 125 and 126 and the busbars 134 (i.e., the arms 134a) may be arranged within the grooves 172 each of which is defined by the adjacent protrusions 171. In this case, the joints between the conductive wire ends 125 and 126 and the arms 134a are preferably press-formed. This results in a decrease in thickness of each of the joints, thereby facilitating arrangement of the conductive wire ends 125 and 126 into the grooves 172 and improving productivity thereof.

As shown in FIG. 23(b), the inside of each of the grooves 172 is preferably filled with a filler. In this case, a gap between each of the protrusions 171 and the corresponding conductive wire ends 125 and 126 is sealed by the filling portion 173 disposed in the groove 172. This structure more appropriately suppresses displacement of the conductive wire ends 125 and 126. Further, since a heat transfer path is formed in intermediate portions of the conductive wire ends 125 and 126, heat dissipation properties of the conductive wire ends 125 and 126 are improved.

The shape of the protrusions 171 (171A and 171B) in a plan view may be arbitrary. For example, the protrusions 171 may be provided as columnar bodies extending from the second surface F2.

FIG. 25 is a longitudinal sectional view showing a configuration near the coil end of the field winding 70. In the field winding 70, since the number of turns of the conductive wire of the winding units 110 of each magnetic pole is larger on the radially outer side than on the radially inner side thereof, a coil end height of the field winding 70 is higher on the radially outer side than on the radially inner side at the coil end. Such structure of the field winding 70 defines the substantially-conical inner space S located radially inside a highest portion of the coil end of the field winding 70. The busbar module 105 is disposed in the inner space S. In the inner space S, the conductive wire ends 125 and 126 of the coil modules 111 and 112 and the arms 134a extending from the busbar module 105 are connected to each other.

On a radially outer side of the busbar module 105, the protrusions 171 projecting in the axial direction from the component holder 141 are formed. Within the inner space S, the conductive wire ends 125 and 126 and the protrusions 171 face each other in a direction orthogonal to the axial direction. The protrusions 171 function to suppress displacement of the conductive wire ends 125 and 126 of the coil modules 111 and 112 in the inner space S on the coil end inner peripheral side of the field winding 70.

The above-described configuration in which the busbar module 105 is arranged in the inner space S on the coil end inner peripheral side of the field winding 70 enables the axial dimension of the axial end portion of the rotor 60 to be decreased. Further, in a configuration in which the conductive wire ends 125 and 126 of the coil modules 111 and 112 extend in the radial direction, the conductive wire ends 125 and 126 are likely to be displaced by force generated in a rotational direction due to rotational fluctuation of the rotor 60, but displacement of the conductive wire ends 125 and 126 is suitably suppressed by the protrusions 171 provided on the component holder 141.

Further, each of the conductive wire ends 125 and 126 of the coil modules 111 and 112 has the tip portion which extends toward the radially inner side of the rotor 60 and connects with a corresponding one of the busbars 134 on the radially inner side of the rotor 60. This layout results in a decrease in degree of force which is generated by centrifugal force or rotational fluctuation of the rotor 60 and acts on the joints between the conductive wire ends 125 and 126 and the busbars 134 in the radial direction or the circumferential direction (i.e., the rotational direction) of the rotor 60 as compared to a configuration in which the conductive wire ends 125 and 126 and the busbars 134 are connected to each other at a position on the radially outer side. It is, therefore, possible to make damage to the joints less likely to occur.

The above-described embodiment provides the following excellent effects.

The rotor 60, as described above, has the support members 163 each of which is disposed in the first surface F1 of the component holder 141 which faces away from the rotor core 61 and surrounds the joints between the arms 145a and 147a (i.e., wire ends) of the busbars 145 and 147. This minimizes the displacement or deformation of ends of the wires extending from the component holder 141 when centrifugal force or rotational fluctuation arising from the rotation of the rotor 60 acts on the joints, thereby suppressing occurrence of inconveniences such as peeling at the joints of the wire ends. This ensures the stability of the joints of the wire ends during the rotation of the rotor 60.

The component holder 141 is, as described above, designed to have formed in the first surface F1 the recesses 161 in which the arms 145a and 147a (i.e., the wire ends) are joined to each other. Further, each of the recesses 161 is filled with the filler which works as the support member 163. Such a structure of the component holder 141 secures a space enabling the wire ends to be joined together within each of the recesses 161 and covers the joints of the wire ends with the filler disposed in the recesses 161. This facilitates joining of the wiring end portions and maintains the wire ends after joined appropriately.

The wire ends drawn out from the component holder 141 are, as described above, joined to each other in a state of being arranged adjacent to each other in the circumferential direction (the joint Y in FIG. 19). This minimizes a possibility of damage to the joints of the wire ends due to centrifugal force during rotation of the rotor 60 as compared to a configuration in which the wire ends are joined to each other in a state of being arranged in the radial direction.

The rotor 60 has formed on the second surface F2 of the component holder 141 the protrusions 171 projecting in the axial direction and facing the conductive wire ends 125 and 126 (i.e., the connecting wires W) in a direction orthogonal to the axial direction. This suppresses unintentional displacement of the conductive wire ends 125 and 126 even when centrifugal force or rotational fluctuation occurs during rotation of the rotor 60. The conductive wire ends 125 and 126 of the coil modules 111 and 112 in the field winding 70 are, therefore, maintained appropriately.

In the field winding 70, when the conductive wire ends 125 and 126 of the coil modules 111 and 112 extend in a direction intersecting the axial direction (that is, the radial direction or the circumferential direction), it causes the conductive wire ends 125 and 126 to be subjected to influences of centrifugal force or rotational fluctuation during rotation of the rotor 60. In order to alleviate a drawback resulting from the centrifugal force or the rotational fluctuation, the protrusions 171 are oriented to face the conductive wire ends 125 and 126 in the direction orthogonal to the axial direction, thereby suppressing displacement of the conductive wire ends 125 and 126.

In each of the winding units 110 of the field winding 70, a space factor of the field winding 70 may be increased by making the number of turns of the conductive wire larger on the radially outer side than on the radially inner side. Further, by providing the joints between the conductive wire ends 125 and 126 and the busbars 134 in the inner space S defined radially inside the highest portion of the coil end of the field winding 70, the axial length of the rotor 60 can be shortened. In the configuration in which the joints between the conductive wire ends 125 and 126 and the busbars 134 are arranged inside the inner space S, the conductive wire ends 125 and 126 extend from the radially outer side toward the radially inner side; however, since the protrusions 171 are formed on the second surface F2 of the component holder 141, displacement of the conductive wire ends 125 and 126 is suitably suppressed. In this case, since the conductive wire ends 125 and 126 (the connecting wires W) and the protrusions 171 are configured to face each other in the direction orthogonal to the axial direction in the inner space S, displacement of each of the conductive wire ends 125 and 126 can be suitably suppressed while shortening the axial length of the rotor 60.

The conductive wire ends 125 and 126 of the coil modules 111 and 112 are configured such that tip portions thereof extend toward the radially inner side and are connected to the busbars 134 of the busbar module 105 at tip portions on the radially inner side. In this case, since the conductive wire ends 125 and 126 and the busbars 134 are connected to each other at the position on the radially inner side, a force acting in the radial direction or the circumferential direction (i.e., the rotational direction) at the joints between the conductive wire ends 125 and 126 and the busbars 134 becomes smaller compared to a configuration in which they are connected to each other at a position on the radially outer side. This suppresses mechanical damage to the joints.

The component holder 141 has formed in the second surface F2 the grooves 172 each of which is defined by adjacent ones of the protrusions 171 and in each of which a corresponding one of the conductive wire end portions 125 and 126 is disposed. The grooves 172 are filled with a given filler, thereby minimizing a risk that the conductive wire end portions 125 and 126 (i.e., the connecting wires W) may be undesirably moved.

### OTHER EMBODIMENTS

The above embodiment may be modified, for example, as follows.

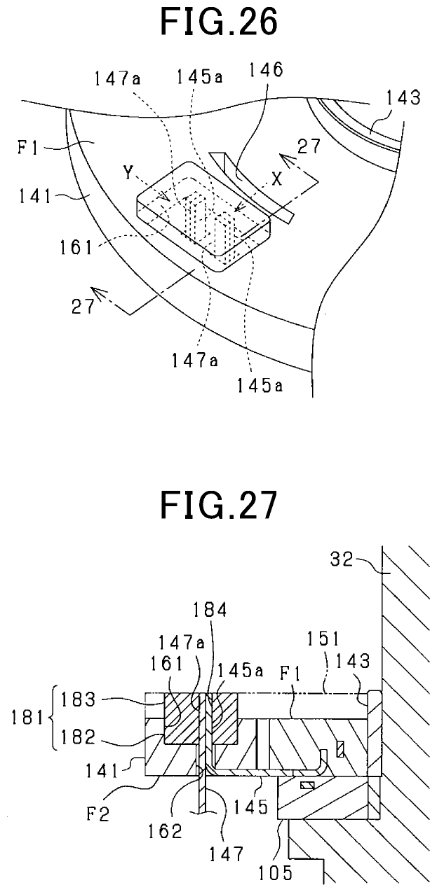

The arrangements of wire connections in the component holder 141 may alternatively be as follows instead of those illustrated in FIGS. 19 and 20. FIG. 26 is an enlarged perspective view showing the arrangements of wire connections in the component holder 141. FIG. 27 is a longitudinal sectional view, taken along line 27-27 in FIG. 26, showing a cross-section of a portion of the component holder 141 where the wire connections are made.

The component holder 141 has the recesses 161 formed in the first surface F1, which faces away from the rotor core 61. The arm 145a of each of the busbars 145 is drawn out into a corresponding one of the recesses 161. Further, in the component holder 141, the arms 147a of the busbars 147 are drawn out into the recesses 161 through the through-holes 162. Then, the arms 145a and 147a are joined to each other in a state of extending in the axial direction from the component holder 141 on a side of the first surface F1.

Further, the first surface F1 of the component holder 141 has the support members 181 tightly fit in the recesses 161. Each of the support members 181 has the fixing portion 182 attached to a corresponding one of the recesses 161 and the protrusion 183 extending in the axial direction from the fixing portion 182 and projecting outside the first surface F1. Further, each of the support members 181 is provided with the insertion portion 184 extending in the axial direction, and a joint between the arms 145a and 147a is inserted through the insertion portion 184.

The fixing portions 182 of the support members 181 are preferably fixed to the recesses 161 of the component holder 141 by ultrasonic welding. However, a fixing means for the support members 181 may be arbitrary, and a configuration in which the fixing portions 182 of the support members 181 are fixed to the recesses 161 by adhesion using an adhesive, or a configuration in which the fixing portions 182 of the support members 181 are fixed to the recesses 161 by press-fitting may be adopted.

The support members 181 are preferably made of resin molded bodies similarly to the component holder 141. However, the support members 181 may alternatively be made of metal such as aluminum. Each of the support members 181 is preferably made of a plurality of discrete parts. For example, each of the support member 181 may be made up of two parts: a radially outer member and a radially inner member that are located on opposite sides of the insertion portion 184, i.e., the joints of the busbars 145 and 147 in the radial direction. Alternatively, each of the support members 181 may be made up of two parts: a first circumferential member and a second circumferential member which are located on opposite sides of the insertion portion 184, i.e., the joints of the busbars 145 and 147 in the circumferential direction.

Each of the support members 181 is arranged to surround the joints between the arms 145a and 147a. This layout serves to minimize displacement of the arms 145a and 147a or occurrence of inconveniences such as peeling of the joints between the arms 145a and 147a when subjected to centrifugal force generated during rotation of the rotor 60.

The arrangements of the wire connections illustrated in FIGS. 26 and 27, unlike those in FIGS. 19 and 20, have the joints between the arms 145a and 147a protruding outside the recesses 161. This facilitates ease with which the joining works to join the busbars 145 and 147 is achieved above the first surface F1. Further, since each of the support member 181 is tightly secured to a corresponding one of the recesses 161 of the component holder 141, tilting of the support members 181 itself due to centrifugal force during rotation of the rotor 60 is suppressed. Further, even if the arms 145a and 147a protrude axially outward from the first surface F1 of the component holder 141, the busbar joints can be suitably supported.

The structure illustrated in FIGS. 26 and 27 is preferably designed such that the heat dissipation plate 151 is prepared which has formed therein axially-extending through-holes or recesses in which the support members 181 are disposed, and then secured to the component holder 141 in a state where the support members 181 are inserted into the through-holes or the recesses. The support members 181 disposed inside the through-holes or the recesses of the heat dissipation plate 151 serve to avoid undesirable interference between the support members 181 and the heat dissipation plate 151. The support members 181 are preferably in physical contact with the heat dissipation plate 151. In a case where the recesses are formed in the heat dissipation plate 151, it is preferable that the support members 181 not be exposed on an axial end surface of the heat dissipation plate 151 opposite to the component holder 141.

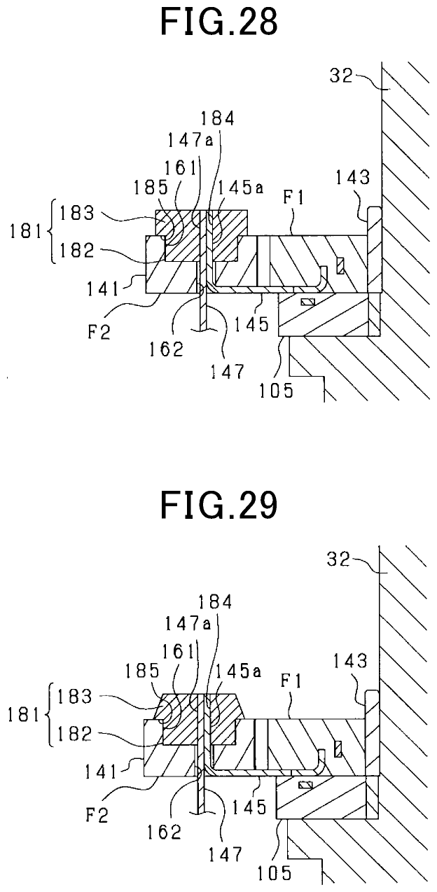

As shown in FIG. 28, each of the support members 181 preferably has the opposing portion 185 facing the first surface F1 of the component holder 141 outside a corresponding one of the recesses 161. The opposing portion 185 is integrally molded with the protrusion 183 projecting in the axial direction from the recess 161 in the support member 181 and has a surface that faces the first surface F1 and is capable of being seated on the first surface F1. The opposing portion 185 preferably has at least one of a configuration of facing the first surface F1 on a radially outer side of the recess 161 and a configuration of facing the first surface F1 on both sides of the recess 161 in the circumferential direction. The opposing portion 185 is preferably a flange-like portion extending in a direction orthogonal to the axial direction.

The opposing portion 185 of each of the support members 181 serves to increase proof stress against centrifugal force generated during rotation of the rotor 60, thereby ensuring greater stability in maintaining the wire ends of the field winding 70 in an appropriate state.

The shape of the opposing portion 185 of each of the support members 181 is changeable. For example, as shown in FIG. 29, the opposing portion 185 may have a tapered shape that becomes wider toward the first surface F1 in longitudinal section. Further, it is also possible for a tapered surface of the opposing portion 185 to be a concave curved surface (R shape).

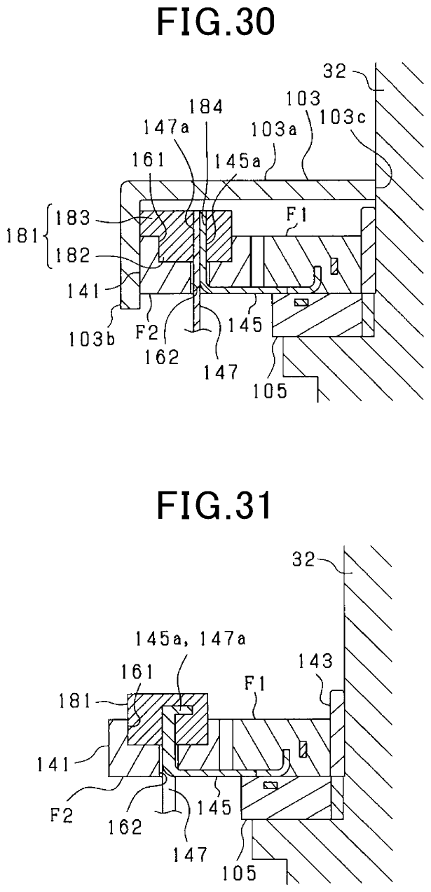

The configuration shown in FIG. 30 may also be adopted. In FIG. 30, the coil end cover 103 has the annular portion 103b which faces the radially outer periphery of each of the support members 181. Specifically, the coil end cover 103 has the end plate portion 103a fixed to the rotating shaft 32, and the annular portion 103b having an annular shape centered on the rotating shaft 32 and extending in the axial direction from an outer edge of the end plate portion 103a. The end plate portion 103a has the hole 103c in a radial center portion, and is fitted and fixed to the rotating shaft 32 at the hole 103c. The annular portion 103b of the coil end cover 103 faces an outer peripheral surface of the component holder 141 and a radial outer surface of each of the support members 181 in the radial direction. The annular portion 103b, the outer peripheral surface of the component holder 141, and the radial outer surface of each of the support members 181 are preferably in contact with each other.

The above-described structure of the coil end cover 103 serves to minimize a risk that the support members 181 may be deformed due to centrifugal force generated during rotation of the rotor 60, thereby enhancing the proof stress against the centrifugal force.

As shown in FIG. 31, each of the joints between the arms 145a and 147a may be bent in a direction intersecting the axial direction. Specifically, axial tip portions of the arms 145a and 147a are bent radially inward (or radially outward), and bent portions extending in the radial direction are joined together. This configuration of the arms 145a and 147a enables axial heights thereof to be reduced, which enhances proof stress of the joints against centrifugal force. Note that, at the tip portions of the arms 145a and 147a, the joints of the arms 145a and 147a are preferably bent in the radial direction after welding is performed. The joints of the arms 145a and 147a may alternatively be bent in the circumferential direction.

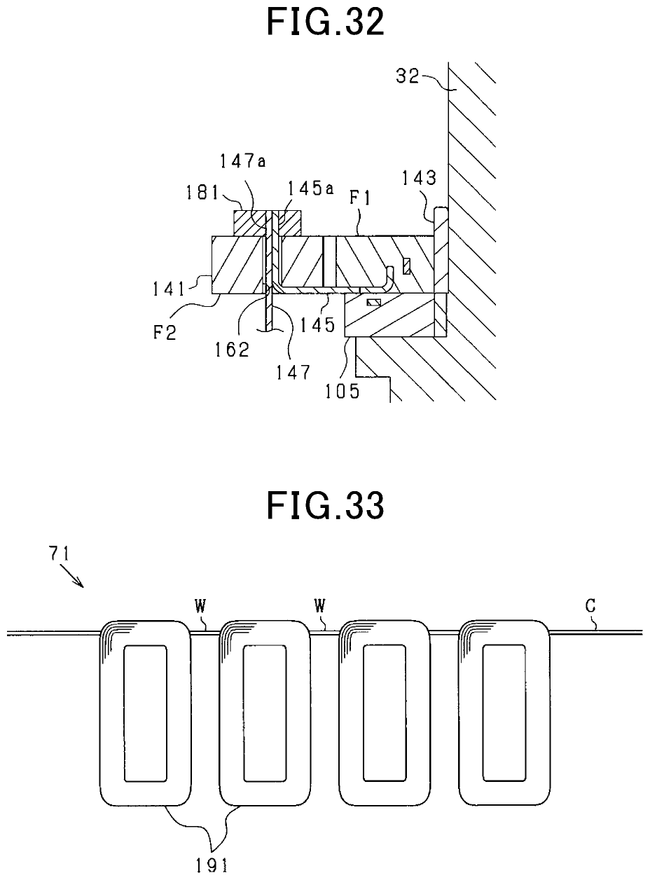

As shown in FIG. 32, it is also possible to fix the support members 181 on the first surface F1 without forming the recesses 161 in the first surface F1 of the component holder 141. Each of the support members 181 is preferably fixed to the first surface F1 of the component holder 141 by adhesion or welding.

In the above embodiments, the joints of the wire ends of the field winding 70 are configured to be surrounded by the support members 163 and 181 from four sides, i.e., both sides facing in the circumferential direction and both sides facing in the radial direction, but this may be modified. For example, a configuration may be adopted in which the joints of the wire ends are surrounded by the support members 163 and 181 from three sides, i.e., both sides facing in the circumferential direction and the radially facing outer side.

The component holder 141 in the above-described embodiments has the first surface F1 where the busbars 145 extending from the electrical components and the busbars 147 are drawn out, and the arms 145a and 147a of the respective busbars 145 and 147 are joined together; however, such a structure may be modified. For example, the conductive wire end portions 125 and 126 of the respective coil modules 111 and 112 may be drawn out to the first surface F1 of the component holder 141, and the conductive wire end portions 125 and 126 may be joined together. Alternatively, either of the conductive wire end portions 125 and 126 and the arm 145a may be joined together. In other words, the combination of the wire ends joined together may be not only a combination of the busbars 145 and 147, but also a combination of busbars and conductive wire ends or a combination of conductive wire ends. In these cases as well, similarly to the above embodiments, it is preferable to adopt a configuration in which the joints of the wire ends are supported by the support members 163 or 181 on the first surface F1 of the component holder 141.

In the above embodiments, as shown in FIGS. 21 and 22, the conductive wire ends 125 and the busbars 134 of the busbar modules 105 serve as the connecting wires W connecting the first coil modules 111 of the respective poles, but this configuration may be modified. For example, the connecting wires W may be configured by directly connecting the conductive wire ends 125 and 126 together, in addition to being configured by connecting the conductive wire ends 125 and 126 of the coil modules 111 and 112 of the respective poles through the busbars 134.

In the field winding 70, the first and second windings 71 and 72 do not have to have a configuration in which the conductive wire ends 125 and 126 are connected to each other using the coil modules 111 and 112, and may have another configuration.

FIG. 33 is a schematic view showing the first winding 71 made up of the pole coils 191 serving as the respective poles. The pole coils 191 are produced by continuously winding the conductive wire C. FIG. 33 illustrates the pole coils 191 each configured as an air-core coil. Portions of the conductive wire C which extend between the adjacent pole coils 191, in other words, intermediate portions of the conductive wire C between the magnetic poles, serve as the connecting wires W. The first winding 71 is preferably produced by arranging a plurality of air-core coils in a continuous form and then assembling the air-core coils to the main poles 62 of the rotor core 61. However, the conductive wire C may be directly wound around the respective main poles 62 of the rotor core 61.

The first winding 71 is, as described above, made up of the pole coils 191 arranged in the circumferential direction, all of which are produced by continuously winding the conductive wire C. However, all the pole coils 191 may be divided into a plurality of groups, and the conductive wire C may be continuously wound to produce the pole coils 191 for each group. For example, the first winding 71 may have another structure as long as the conductive wire C is continuously wound to produce at least two pole coils 191 arranged in the circumferential direction. Although not shown, the same applies to the second winding 72.

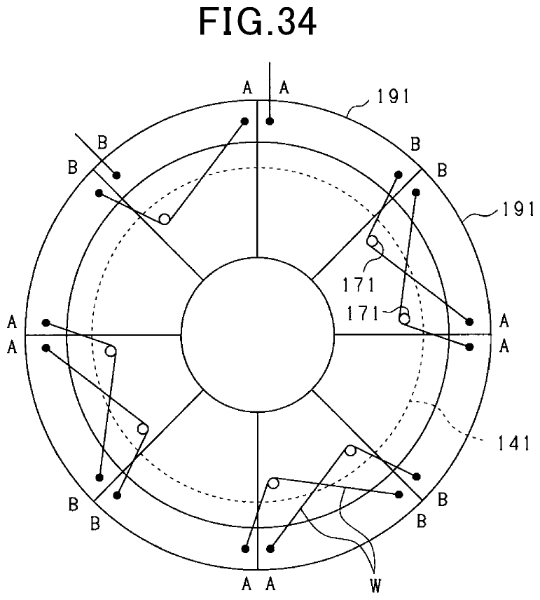

FIG. 34 illustrates a retention structure for the connecting wire W in a case where the pole coils 191 creating the respective poles are continuously wound. FIG. 34 is a plan view of eight pole coils 191 arranged in the circumferential direction to produce the first winding 71 as viewed in the axial direction, and the component holder 141 is indicated by a dash-dot line. Points A and B on both sides in the circumferential direction of each of the pole coils 191 are a starting point and an ending point (i.e., a winding start and a winding end of the conductive wire) of the pole coil 191. Portions of the conductive wire that are located between two respective pole coils 191 arranged adjacent in the circumferential direction and extending between the point B (i.e., the winding end) and the point A (i.e., the winding start) serve as the connecting wires W.

In a case where the pole coil 191 of each pole is configured by continuous winding, it is conceivable that a surplus occurs in the connecting wire W between the poles and the surplus portion becomes slack. When slack occurs in the connecting wire W, there is a concern that the connecting wire W may contact surrounding members or that damage to the connecting wire W may occur during rotation of the rotor 60.

In order to alleviate the above drawback, the configuration of FIG. 34 has the protrusions 171 formed on the component holder 141. The connecting wire W is bridged over each of the protrusions 171. Similarly to the above embodiments, the protrusions 171 project in the axial direction on the second surface F2 of the component holder 141. Such a structure serves to suppress the slack of the connecting wire W and inconveniences caused by the slack of the connecting wire W. Note that the form and number of the protrusions 171 are arbitrary, and the connecting wire W between the poles may be bridged over a plurality of the protrusions 171. For example, when the surplus portion of the connecting wire W is long, the connecting wire W is preferably bridged over a plurality of the protrusions 171 arranged in a zigzag shape or a spiral shape.

The field winding 70 is not limited to a configuration including the first winding 71 and the second winding 72. For example, the field winding 70 may have a configuration in which pole coils of the respective magnetic poles are connected in series without being divided into the first winding 71 and the second winding 72. In the above embodiments, the pole coil of each magnetic pole is configured by the winding unit 110 consisting of the two coil modules 111 and 112 for each magnetic pole, but this may be modified such that the pole coil of each magnetic pole may be configured by one coil module. In this case, an electrical circuit of the rotor 60 is preferably configured to connect a diode to both ends of the field winding 70, or to connect a diode and a capacitor in parallel to both ends of the field winding 70.

The stator core 51 of the stator 50 may be a stator core in which teeth are not provided.

The rotating electrical machine 40 is not limited to a rotating electrical machine for use as a main power source mounted in vehicles. For instance, the rotating electrical machine 40 may be designed as an ISG (Integrated Starter Generator).

The mobile body on which the rotating electrical machine system is mounted is not limited to a vehicle, and may be, for example, an aircraft or a ship. Further, the rotating electrical machine system is not limited to a system mounted on a mobile body, and may be a stationary system.

The above-described embodiment provides the following aspects.

### First Aspect

A wound-field rotor (60) comprises: (a) a rotor core (61) having a plurality of main poles (62) provided for respective magnetic poles; (b) a field winding (70) formed by winding a conductive wire around the main poles; and (c) a circuit module (106) disposed on a first axial end of the rotor core and having an electrical component connected to the field winding. The circuit module includes a component holder (141) that holds the electrical component. The component holder has a first surface and a second surface opposite to each other in an axial direction of the wound-field rotor. The first surface faces away from the rotor core. Wire ends, which are ends of wires leading from the field winding and the electrical component, extend from the component holder and are joined together on or over the first surface. A support member (163, 181) is provided on or in the first surface of the component holder in a state of surrounding a joint between the wire ends.

### Second Aspect

The wound-field rotor according to the above-described first aspect, wherein the component holder has a recess (161) formed in the first surface. The wire ends are drawn out into the recess. The wire ends are joined to each other within the recess. The support member is formed of a filler filled within the recess.

### Third Aspect

The wound-field rotor according to the above-described first aspect, wherein the component holder has a recess (161) formed in the first surface. The wire ends are drawn out into the recess. The support member is provided on the first surface of the component holder in a state of being fixed to the recess and partially protruding from the recess in the axial direction.

### Fourth Aspect

The wound-field rotor according to the above-described third aspect, wherein the support member has an opposing portion (185) that faces the first surface of the component holder outside the recess.

### Fifth Aspect

The wound-field rotor according to the above-described third or fourth aspect, further comprising a coil end cover (103) that covers a coil end of the field winding which is axially outward of the rotor core. The coil end cover has an annular portion (103b) centered on a rotor rotation shaft (32). The annular portion of the coil end cover is disposed to face a radially outer side of a portion of the support member protruding from the recess.

### Sixth Aspect

The wound-field rotor according to any one of the above-described first to fifth aspects, wherein the wire ends to be joined to each other as a combination are drawn out on the first surface of the component holder in a state of being arranged adjacent to each other in a circumferential direction of the wound-field rotor. The wire ends of the combination are joined together and surrounded by the support member.

### Seventh Aspect

The wound-field rotor according to any one of the above-described first to fifth aspects, wherein the wire ends extend in the axial direction on or over the first surface of the component holder. Tip portions of the wire ends form the joint between the wire ends. The joint between the wire ends is bent in a direction intersecting the axial direction.

Although the present disclosure has been described in accordance with the embodiments, it is understood that the present disclosure is not limited to the above-described embodiments or structures. The present disclosure also encompasses various modifications and variations within an equivalent range. In addition, various combinations and forms, as well as other combinations and forms including only one element, more than that, or less than that, are also within the scope and the spirit of the present disclosure.

1. A wound-field rotor comprising:
a rotor core having a plurality of main poles provided for respective magnetic poles;
a field winding formed by winding a conductive wire around the main poles; and
a circuit module disposed on a first axial end of the rotor core and having an electrical component connected to the field winding, wherein
the circuit module includes a component holder that holds the electrical component, the component holder having a first surface and a second surface opposite to each other in an axial direction of the wound-field rotor, the first surface facing away from the rotor core,
wire ends, which are ends of wires leading from the field winding and the electrical component, extend from the component holder and are joined together over the first surface, and
a support member is provided on the first surface of the component holder in a state of surrounding a joint between the wire ends.

2. The wound-field rotor according to claim 1, wherein the component holder has a recess formed in the first surface,
the wire ends are drawn out into the recess,
the wire ends are joined to each other within the recess, and
the support member is formed of a filler filled within the recess.

3. The wound-field rotor according to claim 1, wherein the component holder has a recess formed in the first surface,
the wire ends are drawn out into the recess, and
the support member is provided on the first surface of the component holder in a state of being fixed to the recess and partially protruding from the recess in the axial direction.

4. The wound-field rotor according to claim 3, wherein the support member has an opposing portion that faces the first surface of the component holder outside the recess.

5. The wound-field rotor according to claim 3, further comprising a coil end cover that covers a coil end of the field winding which is axially outward of the rotor core, wherein the coil end cover has an annular portion centered on a rotor rotation shaft, and the annular portion of the coil end cover is disposed to face a radially outer side of a portion of the support member protruding from the recess.

6. The wound-field rotor according to claim 1, wherein the wire ends to be joined to each other as a combination are drawn out on the first surface of the component holder in a state of being arranged adjacent to each other in a circumferential direction, and
the wire ends of the combination are joined together and surrounded by the support member.

7. The wound-field rotor according to claim 1, wherein the wire ends extend in the axial direction over the first surface of the component holder,
tip portions of the wire ends form the joint between the wire ends, and
the joint between the wire ends is bent in a direction intersecting the axial direction.
